(19) United States
(12) Patent Application Publication
(10) Pub. No.: US 2026/0359808 A1
(43) Pub. Date: Nov. 12, 2026

(54) BLOCKCHAIN-BASED COMPUTER FRAMEWORK FOR PROCESSING MICRO-TRANSACTIONS

(71) Applicant: PAYPAL, INC., San Jose, CA (US)

(72) Inventors: Jonathan Cordeau, Colorado Springs, CO (US); May Emil Zabaneh, Austin, TX (US)

(21) Appl. No.: 19/336,213

(22) Filed: Sep. 22, 2025

Related U.S. Application Data
(60) Provisional application No. 63/801,084, filed on May 6, 2025.

(51) Int. Cl. G06Q 20/36

(52) U.S. Cl. CPC G06Q 20/36; G06Q 2220/00

(57) ABSTRACT

Methods and systems are presented for providing a computer framework that facilitates the processing of transactions among different artificial intelligence (AI) agents. An interface is provided that enables communication among AI agents. When a transaction request associated with a transaction between a first AI agent and a second AI agent is detected, a smart contract is generated for the transaction request based on parameters associated with one or more of a first digital wallet associated with the first AI agent and a second digital wallet associated with the second AI agent. When the transaction is associated with a delivery of content from the second AI agent to the first AI agent, the smart contract is generated for automatically transferring a set of tokens from the first digital wallet to the second digital wallet upon detecting a delivery of the content to the first AI agent.

### CROSS REFERENCE TO RELATED APPLICATION

The present application claims priority to U.S. Provisional Patent Application Ser. No. 63/801,084, filed May 6, 2025, which is incorporated herein by reference in its entirety.

### TECHNICAL FIELD

The present specification generally relates to providing a blockchain-based computer framework for processing transactions, including using a particular blockchain architecture such as smart contracts for processing microtransactions, according to various embodiments of the disclosure.

### BACKGROUND

Computer-based transaction systems, particularly those reliant on conventional transaction networks (e.g., credit card networks, etc.), may impose significant delays and operational complexities that lead to inefficient use of computing and network resources, especially when used for high-volume, low-value transactions (also known as microtransactions), such as transactions associated with providing access to and/or subscription of digital content. The delays and operational complexities are exacerbated when the transaction involves parties associated with different transaction networks (e.g., different jurisdictions, different geographical regions, etc.). With the increasing popularity of agentic artificial intelligence (AI) agents that frequently request information from one another (which may correspond to different jurisdictions and/or different geographical regions), the frequency of microtransactions would likely increase dramatically. Thus, there is a need for a computer framework that improves the computational efficiency of processing transactions over conventional transaction systems.

### BRIEF DESCRIPTION OF THE FIGURES

FIG. 1 is a block diagram illustrating an electronic transaction system according to an embodiment of the present disclosure;

FIG. 2 is a block diagram illustrating a data flow for processing a transaction according to an embodiment of the present disclosure;

FIG. 3 illustrates components of a transaction module for facilitating transactions among different artificial intelligence (AI) agents according to an embodiment of the disclosure;

FIG. 4 is a flowchart showing a process of facilitating a transaction among AI agents according to an embodiment of the present disclosure;

FIG. 5 is a block diagram of a system for implementing a device according to an embodiment of the present disclosure;

FIG. 6 illustrates an example computing architecture for facilitating one or more blockchain based transactions according to an embodiment of the present disclosure;

FIG. 7 illustrates an example blockchain network according to an embodiment of the present disclosure; and

FIG. 8 illustrates an example blockchain according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a blockchain-based computer framework that facilitates the processing of transactions among different entities. As discussed herein, conventional transaction systems impose significant delays and computational inefficiencies due to the required processing by different computer systems and/or networks associated with different entities (e.g., financial institutions, etc.) involved in the transactions, and the required verifications of the parties involved in the transactions. Since a large portion of the computation overhead for processing a transaction using conventional transaction processing systems is fixed, such inefficiencies are especially disproportional when processing high-volume, low-value transactions (also referred to as “microtransactions or “micropayment transactions”).

To address such issues, according to various embodiments of the disclosure, a blockchain-based computer framework for processing transactions is provided. The blockchain-based computer framework leverages the efficiency of a blockchain infrastructure to reduce the computational processes required for processing transactions. Instead of relying on computer systems associated with various third-party entities (e.g., third-party financial institutions, etc.) and the transaction networks (e.g., payment networks, etc.) to process transactions, the computer framework disclosed herein enables the processing of the transactions to occur in a Layer 1 and/or Layer 2 of a blockchain network, which substantially reduces the amount of computational resources (e.g., processing of the transactions by separate computer systems associated with different third-party financial institutions, etc.) needed in processing transactions compared to processing such transactions using conventional systems.

In some embodiments, according to the computer framework, a transaction system provides onboarding services for registering various users (e.g., consumers, merchants, vendors, agentic artificial intelligence (AI) agents, etc.) with the transaction system. The transaction system may generate, for each user, a digital wallet that is associated with a particular blockchain, such that blockchain transactions (e.g., transfers of tokens) can be conducted through the digital wallet of the user. In a non-limiting example, the particular blockchain may be associated with a Stablecoin (e.g., PYUSD, etc.). During the onboarding process, the transaction system may also perform the necessary computer processes for verifying information associated with the user (e.g., an identity of the user, a computer security configuration of a user device used to initiate a transaction, etc.).

The transaction system may enable a user to fund the corresponding digital wallet using any currency (e.g., a fiat currency such as U.S. Dollars, a cryptocurrency, etc.). For example, the transaction system may link the digital wallet to one or more funding accounts (e.g., a bank account, a credit card account, another digital wallet, etc.), such that the user may use funds from the one or more funding accounts to fund the digital wallet. The transaction system may convert the funds from the one or more funding accounts of the user to an amount value or a number of tokens corresponding to the particular blockchain, and transfer the tokens from a digital wallet of the transaction system to the digital wallet of the user. The user may then initiate a transaction with the transaction system using the tokens associated with the user's digital wallet (generally referred to below as just the “digital wallet”). The link between the digital wallet and the one or more funding accounts may be generated by inserting metadata that identifies the one or more funding accounts to the digital wallet of the user. The metadata may also include credentials of the user for accessing the one or more funding accounts, such that the transaction system may use the credentials stored in the metadata of the digital wallet to access funds (e.g., withdraw funds, etc.) from the one or more funding accounts on behalf of the user.

The funding of the digital wallet can occur before the user initiates a transaction or at the time that the user initiates the transaction. For example, before a transaction is conducted, the transaction system, based on an instruction from the user or another party or entity, may withdraw funds from the one or more funding accounts, and deposit an equivalent amount value or number of tokens into the digital wallet of the user. In another example, the transaction system may wait until the user initiates a purchase transaction (e.g., for purchasing an item from a merchant, etc.) before funding the digital wallet. At the time the user initiates a purchase transaction, the transaction system may determine if the digital wallet of the user has enough tokens to process the purchase transaction. If the digital wallet of the user does not have enough tokens for processing the purchase transaction, the transaction system may withdraw necessary funds from the one or more funding accounts and deposit tokens into the digital wallet to fund the purchase transaction.

As discussed herein, the user may initiate a transaction with the transaction system. The transaction may involve transferring one or more tokens from the digital wallet of the user to another digital wallet (e.g., a digital wallet of another user). For example, the transaction may be associated with purchasing an item (e.g., goods, services, digital content, etc.) from a merchant. The merchant may also be registered with the transaction system (e.g., through the onboarding service provided by the transaction system, etc.) and has an associated digital wallet created by the transaction system. In some embodiments, the transaction system may process the purchase transaction between the user and the merchant at least partially through the particular blockchain. For example, the transaction system may transfer an amount value or a number of tokens from the digital wallet of the user to the digital wallet of the merchant, by initiating a blockchain transaction with a blockchain network associated with the particular blockchain. One or more computer nodes within the blockchain network may process the blockchain transaction by performing the validation processes (e.g., proof-of-work process, proof-of-stake process, etc.), generating a block, incorporating information associated with the blockchain transaction within the block, and adding the block to the particular blockchain. In some embodiments, the one or more computer nodes may process the blockchain transaction within a Layer 2 network of the particular blockchain to further enhance the computational efficiency of processing the blockchain transaction.

If the transaction was conducted using a conventional transaction processing system (e.g., via a payment card network, etc.), additional computer processing would be required for verifying information associated with both of the user and the merchant during the processing of the transaction. However, using the computer framework as discussed herein, since many of the verification processing of the user and the merchant were completed during the onboarding process with the transaction system prior to initiating the transaction, the additional computer processing can be reduced or eliminated, which enhances the computational efficiency of processing the transaction. Furthermore, the use of the blockchain infrastructure to at least partially process the purchase transaction guarantees the funds to be transferred to the merchant, which reduces or eliminates any computational processing required to assess and reduce the risk of the transaction.

After transferring the tokens from the digital wallet of the user to the digital wallet of the merchant, the transaction system may notify a merchant device associated with the merchant (e.g., a point-of-sale device, a merchant web server, etc.) that the funds have been transferred, such that the merchant can release and/or deliver the item being purchased. The tokens that have been transferred to the digital wallet of the merchant can be maintained within the digital wallet of the merchant, such that the merchant may use the tokens to perform additional transactions (e.g., paying a vendor of the merchant, etc.). In some embodiments, the transaction system may enable a recipient of the tokens (e.g., the merchant in this example, etc.) to specify actions that can be performed using the tokens after receiving the tokens from the user. For example, based on the merchant's instructions, the transaction system may automatically convert the tokens obtained from the digital wallet of the user into another currency (e.g., a fiat currency, another cryptocurrency, etc.), and deposit funds in the other currency in an account that is linked to the digital wallet of the merchant. In some embodiments, the transaction system may generate, for the merchant, programming code that automatically performs the actions specified by the merchant upon detecting, on the particular blockchain, the blockchain transaction that transfers tokens to the digital wallet of the merchant, such that the actions can be performed instantaneously and automatically based on the blockchain transaction.

These actions to be performed on funds received by a digital wallet can be implemented by the transaction system as instructions or parameters that are stored within the digital wallet or in a data storage (e.g., a data record) associated with the digital wallet. In some embodiments, based on the instructions/parameters associated with a digital wallet, the transaction system may generate programming code that is associated with the digital wallet. The programming code, when executed by a machine (e.g., the transaction system, a computer node associated with a blockchain network, etc.), may automatically perform one or more actions corresponding to the parameters specified by the digital wallet (e.g., converting the received tokens to other tokens in other currency, transferring a portion of the received tokens to one or more other digital wallets, etc.) upon detecting a trigger (e.g., a blockchain record on the particular blockchain that transfers tokens to the digital wallet, etc.). In some embodiments, the programming code may be implemented as a smart contract associated with the particular blockchain. The transaction system may record the smart contract on the particular blockchain, such that the blockchain network may monitor the condition (e.g., the blockchain record that transfers tokens to the digital wallet, etc.), and perform the one or more actions upon detecting the condition is satisfied.

The computer framework as described herein can be applied to different computer environments and use cases. For example, the computer framework can be advantageously utilized by digital content providers. Digital content providers typically provide services through a subscription model or a piece-meal model. Under either model, transactions are often conducted in small amounts and/or in high frequencies (e.g., periodically such as every week or every month, every time a piece of digital content is purchased, etc.). These low-amount, high-frequency transactions are also referred to as microtransactions. It is inefficient to process these microtransactions using conventional transaction networks (e.g., credit card payment networks, etc.), since the conventional transaction networks require a substantially large amount of computational processing to be performed during the processing of each of the transactions as discussed herein. The computational overhead for processing a transaction is even larger when the transaction instrument (e.g., a credit card, a debit card, etc.) used by the user for purchasing the digital content is associated with a different transaction network from an account associated with the digital content provider (e.g., cross-border payments, etc.).

As such, the transaction system may process the microtransactions using the computer framework as described herein to improve the computational efficiency in processing the microtransactions. The transaction system may process the microtransactions by transferring tokens from digital wallets of the users who purchase various digital contents from the digital content provider to the digital wallet of the digital content provider. In some embodiments, the transfer of the tokens can also be conducted using a Layer 2 of the blockchain network to further enhance the computational efficiency of processing the microtransactions. Using the Layer 2 of the blockchain network, multiple blockchain transactions corresponding to the microtransactions are processed off-chain, thereby eliminating at least some of the computational requirements for recording the transactions on-chain. The multiple blockchain transactions may be recorded on-chain in the particular blockchain at a later time in a batch manner. In certain situations, some of the blockchain transactions may never be recorded on the blockchain as the tokens transferred to the digital wallet of the digital content provider can be transferred to other digital wallets using the Layer 2 of the blockchain network subsequently before any of the blockchain transactions are recorded on-chain.

For example, based on instructions/parameters provided by the digital content provider, the transaction system may generate custom programming code that, when executed by the transaction system (or another computer node), detects any blockchain transactions associated with the particular blockchain that transfer tokens to the digital wallet of the digital wallet provider, and automatically perform one or more actions to the tokens (e.g., converting the tokens to a fiat currency or another cryptocurrency, transfer at least a portion of the received tokens to another digital wallet, etc.). The custom programming code can be implemented as smart contracts or programming code to be executed by the transaction system or the wallet applications associated with the digital wallets.

Since the blockchain transactions are not associated with any proprietary transaction networks tied to specific regions, the processing of the transactions using the computer framework as described herein enables instant global accessibility without requiring any additional computational processing. For example, the user may use a funding account that is associated with a first geographical region to fund the digital wallet of the user for the transaction with the digital content provider. After receiving the tokens from the digital wallet of the user, the transaction system may convert the tokens to a fiat currency associated with a second geographical region of the digital content provider, and provide the funds in the fiat currency to an account of the digital content provider that is linked to the digital wallet of the digital content provider. For example, the conversion from the tokens to the fiat currency associated with the second geographical region may be performed by programming code (e.g., a smart contract, etc.) generated by the transaction system based on parameters associated with the digital wallet of the digital content provider. Such a transfer of funds between regions is processed instantaneously and efficiently under the computer framework without requiring any additional computational processing that would have been required if the transaction were conducted using conventional transaction networks.

In another example, the computer framework as described herein can be advantageously utilized by transactions conducted by agentic artificial intelligence (AI) agents (also referred to as “AI agents”). Agentic AI agents are AI models (e.g., large-language models, etc.) that can intelligently act (e.g., conduct transactions) on behalf of one or more users without explicit instructions provided by the one or more users. Through an authentication process, the AI agent may obtain credentials associated with the user, such that the AI agent may access resources associated with the user (e.g., a digital wallet of the user with the transaction system) and may conduct transactions using the digital wallet on behalf of the user.

For example, when an AI agent detects a condition associated with a user (e.g., a depletion of an item within a household via communicating with a smart appliance, an expiration of a document, etc.), the AI agent may initiate one or more transactions on behalf of the user. In some embodiments, the AI agent communicates with one or more other AI agents for processing the transactions. For example, if the AI agent detects that a household of the user is out of eggs, the AI agent may communicate with one or more AI agents associated with one or more grocery stores. The AI agent may determine whether the grocery stores have the items needed by the user, and may negotiate with the AI agents (e.g., negotiating an amount, negotiating a payment method, negotiating a delivery service, etc.) for purchasing the item. The AI agent may then initiate a purchase transaction on behalf of the user with one or more of the grocery stores based on the communications with the other AI agents.

Instead of using conventional payment methods to conduct the purchase transaction, the AI agent may initiate the purchase transaction with the transaction system. The transaction system may process the purchase transaction at least partially through the particular blockchain. For example, the transaction system may detect whether the digital wallet has sufficient funds for the purchase transaction, and may communicate with the AI agent to fund the digital wallet if the digital wallet does not have sufficient funds (e.g., the digital wallet has less tokens than the number of tokens required for processing the purchase transaction, etc.). In this regard, the transaction system may also include an AI agent that may work with the AI agent of the user through communications using a natural language. The AI agents may exchange information associated with authorization to access a funding account of the user and funding the digital wallet using funds from the funding account of the user. The AI agent of the transaction system may then process the transaction by initiating a blockchain transaction to transfer tokens from the digital wallet of the user to a digital wallet of a merchant (e.g., a grocery store, etc.) using the techniques described herein. The AI agent of the transaction system may monitor blockchain transactions conducted via the particular blockchain. When the blockchain transaction initiated by the transaction system is detected, the AI agent of the transaction system may communicate with the AI agent of the user and/or the AI agent of the merchant regarding the completion of the transaction, such that the merchant may deliver the item to the user.

In some embodiments, the transaction conducted between human users (or between AI agents on behalf of the users) may require (or result in) multiple transactions that involve multiple parties. For example, in order to renew a document (e.g., an identity document, etc.) with an agency, a user (or an AI agent acting on behalf of the user) may be required to initiate a transaction for paying an application fee to the agency (or an AI agent acting on behalf of the agency), which in turn may be required to pay multiple vendors for providing different materials (e.g., the physical document, a photo, testing services, etc.) for the renewal document. The transaction system may advantageously further enhance the computational efficiency of processing such transactions by streamlining the transactions.

In this example, the digital wallet of the agency may be associated with instructions to automatically transfer any tokens received from other digital wallets to one or more digital wallets of one or more vendors. As discussed herein, the transaction system may generate custom programming code (e.g., a smart contract, etc.) for automatically detecting a blockchain transaction that transfers tokens to the digital wallet of the agency and automatically transferring at least a portion of the tokens to different digital wallets of the different vendors. As such, the custom programming code may be used to monitor blockchain transactions associated with the digital wallet of the agency. Upon detecting a blockchain transaction that transfers tokens to the digital wallet of the agency, the custom programming code, when executed by a device, may automatically transfer a portion of the tokens to other digital wallets of the vendors.

In some embodiments, in order to further enhance the computational efficiency of processing the transactions, the transaction system may eliminate some of the blockchain transactions by directly transferring tokens from the digital wallet of the user (the user who initiated a transaction with the agency, etc.) to the digital wallet(s) of the ultimate destination of the transactions (e.g., the digital wallets of the vendors). In this regard, the transaction system may analyze custom programming code generated for and associated with different digital wallets, and may modify the custom programming code and migrate the modified custom programming code from one digital wallet to another digital wallet. Using the example illustrated above, after analyzing the custom programming code generated for the agency (e.g., programming code that detects blockchain transactions that transfer tokens to the digital wallet of the agency and automatically transfer at least some of the tokens to a digital wallet of a vendor, etc.), the transaction system may modify the custom programming code and migrate it from the digital wallet of the agency to the digital wallet of the user. For example, the transaction system may modify the custom programming code such that it can be executed in association with the source digital wallet (e.g., the digital wallet of the user) instead of the recipient digital wallet (e.g., the digital wallet of the agency), such that when the user (or the AI agent of the user) initiates the transaction to pay the agency, the digital wallet of the user (or the transaction system) may automatically convert the transaction from transferring the entire set of tokens to the digital wallet of the agency, to transferring a portion of the tokens to the digital wallet of the agency and transferring another portion of the tokens directly to the digital wallet of the vendor (bypassing the digital wallet of the agency). The ability to detect automatic action trigger(s) and modify and/or migrate the action trigger(s) further enhances the computational efficiency of processing transactions using the computer framework.

While performing services for a user, an AI agent may be required to obtain additional information from other entities (or AI agents of the other entities). For example, the AI agent may be required to obtain additional information on how to perform the services for the user (e.g., how to log in to a website, how to create an item for the user, etc.). In some embodiments, a first AI agent of the user may interact with a second AI agent to obtain the additional information. For example, the first AI agent of the user may submit one or more queries to the second AI agent via an interface. Based on the one or more queries, the second AI agent may generate a response that includes content that is usable by the first AI agent to perform the services for the user. A substantial amount of computer resources, such as processing power, memory usage, etc., may be required to generate the response for the first AI. For example, the execution of the second AI agent to analyze the one or more queries, and to generate the responses may require processes performed by one or more large language models. In a non-limiting example, the second AI agent may use a first large language model to modify the queries submitted by the first AI agent, a second large language model to retrieve relevant documents that includes content usable by the second AI agent to generate the response for the first AI agent (e.g., using a retrieval-augmented generation (RAG) framework, etc.), and a third large language model to digest the retrieved documents and to generate the response (e.g., summarizing portions of the content in the document to answer the queries, etc.). As such, the second AI agent may require an exchange of one or more tokens for the generation of the response. Since each of these transactions between the AI agents typically involve a small amount value or number of tokens (e.g., microtransactions), the transaction system as disclosed herein may facilitate the transactions between the AI agents more efficiently than conventional transaction processing systems.

In some embodiments, the transaction system may provide an interface (e.g., a chat interface, an application programming interface, etc.) that enables different AI agents to communicate and initiate transactions with each other. Using the example illustrated above, the first AI agent may submit the query to the second AI agent via the interface provided by the transaction system. When the transaction system detects the query submitted by the first AI agent intended for the second AI agent, the transaction system may generate custom programming code (e.g., a smart contract associated with the blockchain, etc.) for facilitating the transaction between the first AI agent and the second AI agent. For example, the transaction system may generate custom programming code that, when executed by a machine, automatically process a transfer of one or more tokens from a digital wallet associated with the first AI agent to a digital wallet associated with the second AI agent upon detecting a condition. The condition may be associated with a delivery of content (e.g., a response) by the second AI agent to the first AI agent.

In some embodiments, the custom programming code may be generated based on parameters associated with the digital wallet of the second AI agent, which may specify an amount value or a number of tokens to be transferred in each content delivery transaction and/or a metrics for calculating the amount value or the number of tokens to be transferred in a transaction. The metrics may be based on attributes associated with the content being delivered to the requesting AI agent, which may include one or more of a quantity of the content, a quality of the content, a quantity and/or the quality of the documents retrieved in support of the generation of the response by the second AI agent, etc. As such, the transaction system may incorporate the metrics within the custom programming code. If the custom programming code is implemented as a smart contract, the transaction system may record the smart contract on the blockchain. The custom programming code, when executed by a machine (e.g., a computer node of the blockchain network, etc.), may monitor the condition (e.g., a delivery of content such as a response provided by the second AI agent to the first AI agent via the interface, etc.), may determine an amount value or a number of tokens for the transaction (based on an evaluation of the content provided to the first AI agent and/or the documents retrieved in support of the generation of the content provided to the first AI agent, etc.), and may automatically transfer the amount value or the number of tokens from the digital wallet of the first AI agent to the digital wallet of the second AI agent (e.g., broadcasting a blockchain record associated with the token transfer transaction to the blockchain network, etc.). As such, using the blockchain-based computer framework, transactions among various different AI agents can be facilitated and processed in an efficient manner.

While many examples illustrated here are related to the processing of microtransactions, it has been contemplated that other types of transactions (e.g., transactions that are not low in value, recurring payments such as rent payment, tuition payment, etc.) can advantageously be processed using the computer framework disclosed herein for improving the security and computer resource efficiency of the transactions.

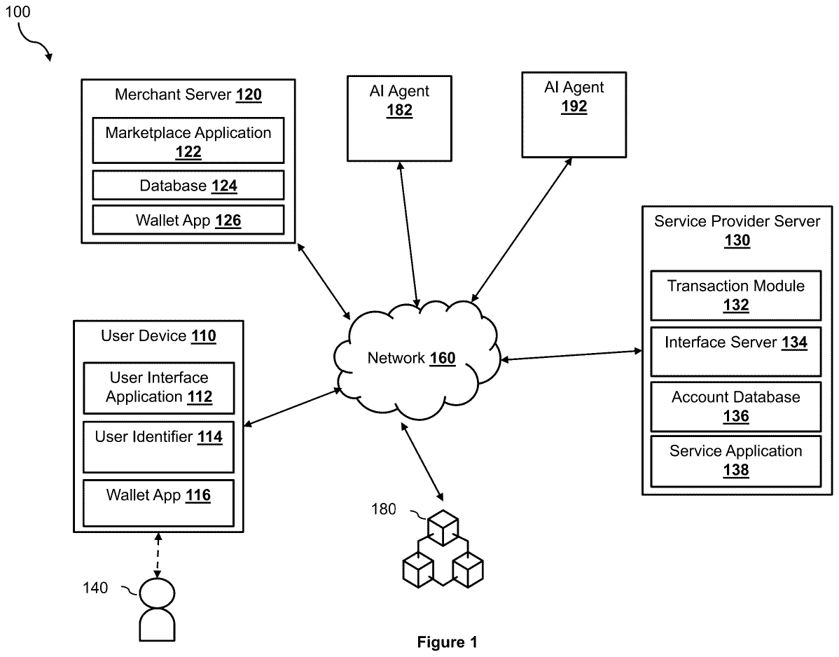

FIG. 1 illustrates an electronic transaction system 100, within which the computer framework may be implemented according to one or more embodiments of the disclosure. The electronic transaction system 100 includes a service provider server 130, a merchant server 120, a user device 110, artificial intelligence (AI) agents 182 and 192, and a blockchain network 180 that may be communicatively coupled with each other via a network 160. The network 160, in one embodiment, is implemented as a single network or a combination of multiple networks. For example, in various embodiments, the network 160 includes the Internet and/or one or more intranets, landline networks, wireless networks, and/or other appropriate types of communication networks. In another example, the network 160 comprises a wireless telecommunications network (e.g., cellular phone network) adapted to communicate with other communication networks, such as the Internet.

The user device 110, in one embodiment, is utilized by a user 140 to interact with the merchant server 120 and/or the service provider server 130 over the network 160. For example, the user 140 uses the user device 110 to conduct an online transaction or in-person transaction, such as a purchase transaction, a data access transaction, a content subscription transaction, or any other interactions with the merchant server 120 with the merchant server 1020 via websites hosted by, or mobile applications associated with, the merchant server 1020. The user 140 also logs in to a user account to access account services or conduct electronic transactions (e.g., data access, account transfers or payments, etc.) with the service provider server 130. The user device 110, in various embodiments, is implemented using any appropriate combination of hardware and/or software configured for wired and/or wireless communication over the network 160. In various implementations, the user device 110 includes at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 1020 and/or the service provider server 1030 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 1012 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include a wallet application 116 associated with a particular blockchain (e.g., associated with the blockchain network 180). The wallet application 116 may be linked to a digital wallet associated with the user 140, and may provide an interface to the user 140 to access data and functionalities using the digital wallet of the user (e.g., initiate a payment transaction, etc.). In some embodiments, the digital wallet of the user 140 includes data associated with the particular blockchain, such as an identifier (e.g., an address, etc.) that can be used to uniquely identify the digital wallet among the various digital wallets registered with the transaction system. The digital wallet may be used to hold (e.g., store, etc.) values (e.g., tokens) associated with the particular blockchain. By processing (e.g., recording) transactions that transfer one or more tokens to the digital wallet (e.g., based on the identifier of the digital wallet) on the particular blockchain, the digital wallet may hold the one or more tokens that can be used (e.g., to spend) in subsequent transactions by the user 140.

As such, the wallet application 116 may enable the user 140 to initiate or be used in an electronic transaction (e.g., an electronic purchase transaction, an electronic peer-to-peer fund transfer transaction, etc.). In response to receiving a request for a payment associated with an electronic transaction, the wallet application 116 may communicate with the service provider server 130 to generate and process a transaction (e.g., a token transfer transaction) for transferring one or more tokens from the digital wallet of the user 140 to another digital wallet, or vice versa.

In some embodiments, the wallet application 116 may identify another party in the transaction (e.g., a sender or a recipient of the transaction, etc.) via different methods, for example, by scanning a code (e.g., a QR code, etc.) associated with the other party, by establishing a near-field communication (NFC) connection with another device (e.g., a point-of-sale device of a merchant, etc.) associated with the other party, by providing a list of contacts associated with the user 140 and receiving a selection of one of the contacts from the user 140, by receiving an identifier (e.g., a phone number, an email address, etc.) from the user 140, etc. For example, when the user 140 is purchasing items from a store of a merchant, the user 140 may use the wallet application 116 to initiate a payment transaction with the merchant by scanning a code associated with the merchant, by establishing an NFC with a point-of-sale (POS) device at the store, etc. In another example, when the user 140 initiates a funds transfer transaction, the wallet application 116 may receive, from the user 140, an identifier of the recipient user (e.g., receiving a selection of a contact on the user device 110, receiving a phone number or other contact information of the recipient user, etc.). After receiving the identity of the recipient, the wallet application 116 may transmit information associated with the other party in the payment transaction to the service provider server 130 to process the payment transaction.

Instead of using the wallet application 116, the user 140 may also access the digital wallet of the user 140 via another interface, such as the UI application 112. For example, when the user 140 is purchasing items from an online store, the user 140 may log on to the digital wallet account of the user 140 via the interface provided by the online store, and initiate the payment through the digital wallet of the user 140.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard or a microphone) of the user device 110. For example, the user 140 may use the input component to interact with the UI application 112 (e.g., to conduct a purchase transaction with the merchant server 120 and/or the service provider server 130, to initiate a peer-to-peer funds transfer transaction with another user, etc.).

While only one user device 110 is shown in FIG. 1, it has been contemplated that multiple user devices, each associated with a different user, may be connected to the merchant server 120 and the service provider server 130 via the network 160.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items, content, and/or services for purchase and process payments for the purchases. The merchant server 120 may include a merchant database 124 for identifying available items, content, or services, which may be made available to the user device 110 and/or the AI agents 182 and 192 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the service provider server 130) may interact with the marketplace application 122 through the user interface application 112 over the network 160 to search and view various items, content, or services available for purchase in the merchant database 124, and initiate a purchase transaction with the merchant server 120.

The merchant server 120, in one embodiment, includes a wallet application 126 that can be used by the merchant server 120 to access a digital wallet associated with the merchant. Via the digital wallet, the merchant may receive payments from users (e.g., the user 140, etc.) and/or making payments to other entities (e.g., a vendor, etc.).

While only one merchant server 120 is shown in FIG. 1, it has been contemplated that multiple merchant servers, each associated with a different merchant, may be connected to the user device 110 and the service provider server 130 via the network 160.

Each of the AI agents 182 and 192 may include computer software (e.g., a large language model, a small language model, etc.) that is executed on a computer device (e.g., a cloud server, etc.). In some embodiments, each of the AI agents 182 and 192 may process transactions on behalf of different users. For example, the user 140 may use an AI agent (e.g., the AI agent 182) to conduct transactions on behalf of the user 140. By communicating with the AI agent 182 via the user device 110, the user 140 may provide general or specific instructions to the AI agent 182, such that the AI agent 182 may intelligently perform transactions on behalf of the user. Furthermore, through the communication between the user 140 and the AI agent 182, the AI agent 182 may obtain credentials associated with the user 140, such that the AI agent 182 may access various computer resources associated with the user 140, such as the digital wallet of the user, a funding account of the user, etc. For example, the user 140 may provide instructions to the AI agent 182 to purchase various items for a household when a quantity of those items is below a certain quantity, or to renew any documents that are within a time period from the expiration date. The AI agent 182 may be configured to communicate with other devices and/or AI agents (e.g., the AI agent 192) to monitor various items/documents, and may initiate a transaction with another system (e.g., a merchant associated with the merchant server 120, etc.) or an AI agent when a particular condition is detected. For example, the AI agent 192 may be used by the merchant of the merchant server 120 to conduct transactions on behalf of the merchant. The AI agent 192 may interact with other AI agents (e.g., the AI agent 182) to communicate and negotiate parameters associated with a transaction conducted between the user 140 and the merchant of the merchant server 120.

The service provider server 130, in one embodiment, is maintained by a transaction processing entity or an online service provider, which provides processing of electronic transactions between users (e.g., the user 140 and users of other user devices, etc.) and/or between users and one or more merchants. As such, the service provider server 130 includes a service application 138, which may be adapted to interact with the user device 110 and/or the merchant server 120 over the network 160 to facilitate the electronic transactions (e.g., electronic payment transactions, data access transactions, etc.) and/or other types of interactions (e.g., chat sessions, etc.) among users and merchants processed by the service provider server 130. In one example, the service provider server 130 is provided by PayPal®, Inc., of San Jose, California, USA, and/or one or more service entities or a respective intermediary that provide multiple point of sale devices at various locations to facilitate transaction routings between merchants and, for example, service entities.

In some embodiments, the service application 138 includes a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 also includes an interface server 134 that is configured to serve content (e.g., web content) to users and interact with users. For example, the interface server 134 includes a web server configured to serve web content in response to HTTP requests. In another example, the interface server 134 includes an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 stores a log-in page and is configured to serve the log-in page to users for logging into user accounts (e.g., digital wallets, etc.) of the users to access various services provided by the service provider server 130. The interface server 134 may also include other electronic pages associated with the different services (e.g., electronic transaction services, etc.) offered by the service provider server 130. As a result, a user (e.g., the user 140, or a merchant associated with the merchant server 120, etc.) may access a user account associated with the user and access various services offered by the service provider server 130, by generating HTTP requests directed at the service provider server 130.

The service provider server 130, in one embodiment, is configured to maintain one or more user accounts and merchant accounts in an accounts database 136, each of which may be associated with a profile, data associated with a digital wallet, and may include account information associated with one or more individual users (e.g., the user 140 associated with user device 110, etc.) and merchants. For example, account information of a user includes the data associated with the digital wallet of the user (e.g., an identifier of the digital wallet, external funding accounts information of accounts that are linked to the digital wallet, instructions of parameters usable by the service provider server to perform actions for the digital wallet, etc.) data associated with one or more external funding accounts of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein may be implemented within the service provider server 130 or external to the service provider server 1030 (e.g., implemented in a cloud, etc.).

In one implementation, a user has identity attributes stored with the service provider server 130, and the user has credentials to authenticate or verify identity with the service provider server 130. User attributes may include personal information, user identifiers (e.g., the user identifier 114, etc.) banking information and/or funding sources. In various aspects, one or more of the user attributes are passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 includes a transaction module 132 that facilitates processing of transactions among various users (e.g., consumers, merchants, or other types of users, etc.) using the computer framework described herein. The transaction module 132 may communicate with the user device 110 and/or the wallet application 116 executed on the user devices to provide the functionalities disclosed herein. For example, during an onboarding process of a new user (e.g., the user 140, etc.), the transaction module 132 may generate a new digital wallet for the user that is usable for conducting transactions on the blockchain network 180. The digital wallet may be generated in the form of a computer software data structure (e.g., a container, a data record, a software object, etc.), which can be stored on the service provider server 130 (e.g., in the account database 136, etc.). The transaction module 132 may assign a new identifier (e.g., an address, etc.) that can be used to uniquely identify the digital wallet. Via the interface provided by the interface server 134, the transaction module 132 may obtain information associated with the user, and may store the information within the digital wallet or in another data storage that is associated with the digital wallet. The information may include user information such as a name of the user, contact information (e.g., a phone number, an email address, etc.) of the user, etc. The information may also include account information associated with one or more external accounts of the user that can be used to fund the digital wallet, such as an account number, credential information for accessing the account, etc. By storing the account information in association with the digital wallet, one or more links are generated between the one or more external accounts and the digital wallet. The user may then provide instructions to the transaction module 132 to fund the digital wallet using an external account. For example, the transaction module 132 may withdraw funds from the external account of the user, and may then transfer one or more tokens from a digital wallet associated with the service provider server 130 to the digital wallet that has been generated for the user. A transaction record that represents the transfer of the one or more tokens to the digital wallet of the user may be broadcasted to the blockchain network 180 and then recorded on the particular blockchain. Such a transaction record indicates a stored value (e.g., a number of tokens, etc.) that is associated with the digital wallet and that can be used by the user to conduct subsequent transactions through the digital wallet.

For example, the transaction module 132 may receive, from the user, a request for processing an electronic transaction. The electronic transaction may be associated with a purchase transaction, a data access transaction, a content subscription transaction, etc. The request may specify an amount value or a number of tokens needed for processing the transaction and an identifier (e.g., an address) associated with a recipient digital wallet (e.g., a digital wallet of a merchant, etc.). Upon receiving the request for processing the electronic transaction, the transaction module 132 may first determine if the digital wallet of the user has sufficient tokens for processing the electronic transaction. If it is determined that the digital wallet does not have sufficient tokens for processing the electronic transaction, the transaction module 132 may fund the digital wallet of the user using one or more of the external accounts of the user based on the data (e.g., metadata, etc.) associated with the digital wallet of the user. Funding the digital wallet increases the stored value (e.g., the tokens) of the digital wallet, which may then be used in a blockchain transaction. The transaction module 132 may then initiate one or more blockchain transactions with the blockchain network 180 to transfer a number of tokens from the digital wallet of the user to the digital wallet(s) of other entities (e.g., the merchant of the merchant server 120, vendors of the merchant, etc.) to complete the transaction. In some embodiments, the one or more blockchain transactions may be initiated based on one or more parameters associated with the recipient digital wallet. For example, the recipient digital wallet may specify instructions for transferring a portion of the tokens received by the recipient digital wallet to one or more other digital wallets (e.g., digital wallets associated with vendors of the merchant, etc.). As such, the transaction module 132 may perform actions (e.g., additional blockchain transactions, etc.) based on the instructions associated with the recipient digital wallet.

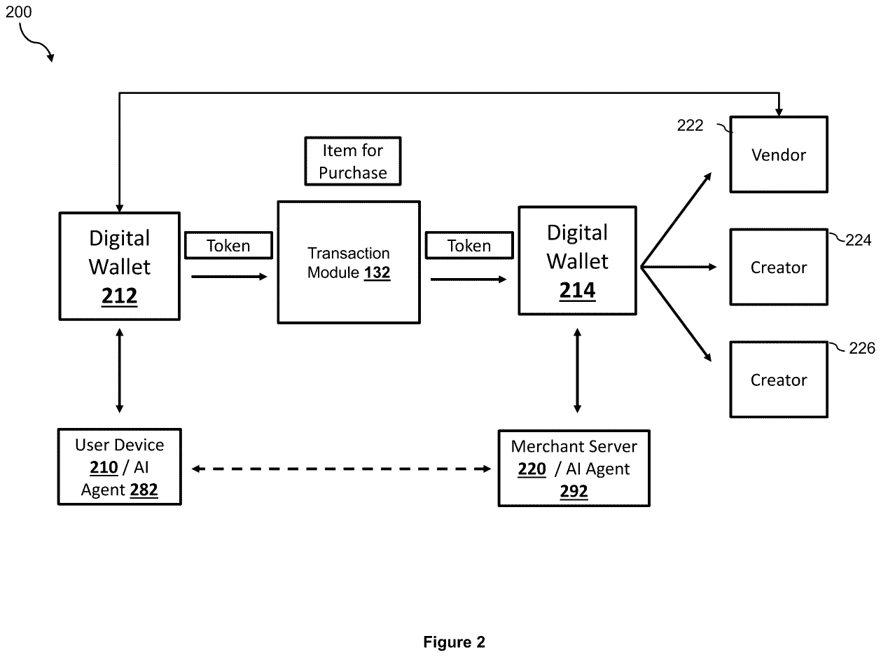

FIG. 2 illustrates a data flow 200 of a transaction conducted using the computer framework according to an embodiment of the disclosure. In the example illustrated in FIG. 2, the user 140 and/or the AI agent 182 may initiate a transaction with the transaction module 132. For example, the transaction may be associated with purchasing an item (e.g., goods, services, digital content, etc.) from a merchant (e.g., the merchant associated with the merchant server 120, etc.). Upon receiving a request to process the transaction, the transaction module 132 may determine whether the digital wallet 212 of the user 140 has sufficient tokens for the transaction. If the digital wallet 212 has insufficient tokens for the transaction, the transaction module 132 may use the credentials of the user stored in the metadata of the digital wallet 212 to withdraw funds from a funding account that is linked to the digital wallet, and convert the funds to tokens associated with the blockchain network 180. The transaction module 132 may initiate one or more blockchain transactions to transfer the tokens to one or more digital wallets to complete the transaction for the user 140. For example, the transaction module 132 may transfer the tokens from the digital wallet 212 of the user 140 to the digital wallet 214 of the merchant.

In some embodiments, the transaction module 132 may generate a computer software program or programming code in association with the digital wallet 214 for performing additional actions specified by the digital wallet 214. For example, the merchant may specify actions to be performed upon receiving tokens at the digital wallet 214 to the transaction module 132. The transaction module 132 may store the instructions within the digital wallet 214 or in a data storage in association with the digital wallet 214. The transaction module 132 may also generate the computer software program or programming code based on the instructions, such that the computer software program or programming code, when executed by a machine (e.g., by the service provider server 130, by any one of the computer nodes within the blockchain network 180, etc.), may perform the actions for the merchant. The computer software program or the programming code may be implemented as a smart contract, which may be recorded on the particular blockchain, such that it may be executed by the blockchain network 180.

The one or more actions may include converting the one or more tokens (or a portion thereof) associated with the blockchain network 180 to a fiat currency or to another cryptocurrency. The one or more actions may also include transferring at least a portion of the one or more tokens to other digital wallets, such as a digital wallet associated with a vendor 222, a digital wallet associated with a creator 224 of digital content, a digital wallet associated with another creator 226 of digital content, etc. As such, after recording a transaction for transferring one or more tokens from the digital wallet 212 to the digital wallet 214, a device executing the computer software program (e.g., a computer node associated with the blockchain network 180, the service provider server 130, etc.) may detect that the transaction has been recorded in a block on the particular blockchain, and may perform the actions specified by the digital wallet 214.

In some embodiments, the transaction module 132 may further enhance the computer efficiency of processing the blockchain transactions by modifying, migrating, and/or removing some of the computer software program. For example, the transaction module 132 may analyze the computer software programs generated for different users (e.g., the merchant, the vendor, the content creators, the user 140, etc.). When the transaction module 132 determines that the computer software program associated with the digital wallet 214 is configured to automatically forward at least a portion of the tokens received by the digital wallet 214 to one or more other digital wallets, the transaction module 132 may modify the computer software program and may migrate the modified computer software program from the digital wallet 214 to other digital wallets that have previously been used to transfer tokens to the digital wallet 214.

For example, the modified computer software program may then be associated with the digital wallet 212 and/or the transaction module 132. When a transaction is initiated for transferring tokens from the digital wallet 212 to the digital wallet 214, the modified computer software program may be triggered (e.g., executed, etc.). Instead of transferring the tokens to the digital wallet 214, the device executing the computer software program may transfer only a portion of the tokens to the digital wallet 214, and directly transfer another portion of the tokens from the digital wallet 214 to the other digital wallet(s) as specified by the digital wallet 214, thereby further reducing the computer processing complexity of processing the transaction for the user 140.

As discussed herein, AI agents may also conduct transactions among each other. In particular, agentic AI agents, which are AI models (e.g., large language models, small language models, etc.), can intelligently perform tasks on behalf of users. When performing tasks for a user, the AI agent may process transactions on behalf of the user using the digital wallet of the user. For example, an AI agent of a user (e.g., the AI agent 182 of the user 140, etc.) may initiate a transaction with the merchant server 120 for purchasing one or more items from the merchant server 120. The AI agent 182 may interact with another AI agent of the merchant server 120 (e.g., the AI agent 192, etc.) to determine (e.g., negotiate, etc.) the specific parameters (e.g., a number of tokens, shipping arrangements, etc.) for the transaction. The AI agent 182 may then initiate a blockchain transaction to transfer the number of tokens from the digital wallet of the user 140 to a digital wallet of the merchant server 120.

In another example, instead of purchasing one or more items from a merchant, the AI agent 182 of the user 140 may submit a query for information associated with a subject (e.g., summarizing court rulings on a legal matter, obtaining historical information based on books from a library or a museum, etc.). The AI agent may submit 182 the query to another AI agent (e.g., the AI agent 192, etc.). Based on the query, the AI agent 192 may retrieve relevant documents that are usable to generate a response to the query using a retrieval-augmented generation (RAG) approach, and may provide the response to the AI agent 182. Due to the resources (e.g., computational resources, data access resources, etc.) required to generate the response to the query, the AI agent 192 may request that the AI agent 182 provide a number of tokens as an exchange. As such, the AI agent 182 may access the digital wallet of the user 140, and may initiate a blockchain transaction to transfer the number of tokens to a digital wallet associated with the AI agent 192 for the information request. In some embodiments, the transaction module 132 may be configured to facilitate the transactions among various AI agents.

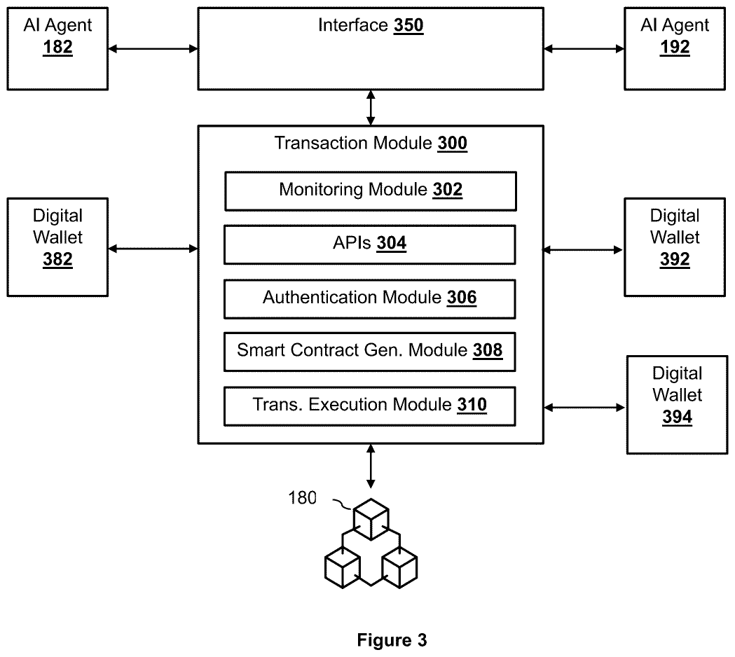

FIG. 3 illustrates a transaction module 300 that is configured to facilitate transactions among AI agents according to various embodiments of the disclosure. In some embodiments, the transaction module 300 corresponds to the transaction module 132 of the service provider server 130. As shown, the transaction module 300 includes a monitoring module 302, application programming interfaces (APIs) 304, an authentication module 306, a smart contract generation module 308, and a transaction execution module 310.

AI agents, such as the AI agents 182 and 192, may communicate with each other via an interface 350. In some embodiments, the interface 350 may be implemented as a chat interface, an API, or other types of interfaces that enable the AI agents to communicate and transmit instructions with each other. The interface 350 may be provided by the transaction module 300 or by a third-party entity. When the interface 350 is implemented as a chat interface, the monitoring module 302 may monitor the interactions among different AI agents via the interface 350. Based on analyzing the communication among the different AI agents, the monitoring module 302 may detect a triggering event for initiating a transaction between two AI agents. For example, the monitoring module 302 may detect the transmission of any trigger words, such as “purchase,” “buy,” “pay,” etc. within the communications among the AI agents. When a word or words are detected that indicate a triggering event, such as a purchase, for a transaction, the monitoring module 302 may initiate a blockchain transaction based on the context derived from the communications between the AI agent.

The APIs 304 defines a set of API calls (e.g., functions, etc.) that can be made by AI agents. The API calls may enable the AI agents to request for different services offered by the transaction module 300, such as to initiate a blockchain transaction, inquiring a status of a blockchain transaction, creating and/or configuring instructions that specify actions to be performed in association with one or more digital wallets, and other services. In some embodiments, the API calls associated with the APIs 304 can be made via the interface 350. For example, an AI agent may transmit the syntax of an API call via a chat interface. The monitoring module 302 may be configured to detect an API call (e.g., using the name of the API call as a trigger word, etc.), and may initiate a transaction for the requesting AI agent based on the API call. In some embodiments, an AI agent may directly submit an API call to the transaction module 300.

Upon receiving a request to process a transaction from an AI agent (e.g., the AI agent 182, etc.), the transaction module 300 may use the authentication module 306 to authenticate the AI agent for accessing a digital wallet. For example, the AI agent 182 may submit credentials associated with the digital wallet of the user 140 to the transaction module 300 (e.g., as one of the parameters in the API call, etc.). The authentication module 306 may authenticate the AI agent 182 for accessing the digital wallet of the user 140 (e.g., processing a transaction using the digital wallet) based on the credentials.

After authenticating the AI agent 182, the transaction module 300 may facilitate the processing of the transaction for the AI agent 182. The transaction requested by the AI agent 182 involves transferring one or more tokens to a digital wallet associated with another AI agent (e.g., the AI agent 192) in exchange for certain services (e.g., purchase of an item, accessing information, responding to a query, a subscription of content, etc.). In some embodiments, instead of immediately transferring the one or more tokens from the digital wallet associated with the AI agent 182 to the digital wallet associated with the AI agent 192 upon receiving the request from the AI agent 182, the transaction module 300 may use the smart contract generation module 308 to generate a smart contract for the request. The smart contract generation module 308 may generate a smart contract that dynamically transfers tokens from the digital wallet associated with the AI agent 182 to the digital wallet associated with the AI agent 192 based on criteria that is related to the request.

For example, if the request is associated with accessing data (e.g., streaming content, information associated with a particular domain, etc.) from the AI agent 192, the smart contract generation module 308 may generate a smart contract that triggers a transfer of tokens from the digital wallet associated with the AI agent 182 to the digital wallet associated with the AI agent 192 upon detecting a transfer of the data from the AI agent 192 to the AI agent 182. In some embodiments, the smart contract may also be generated to dynamically determine the number of tokens to be transferred from the digital wallet associated with the AI agent 182 to the digital wallet associated with the AI agent 192 based on factors, such as a quantity and/or a quality of the data provided to the AI agent 182.

As discussed herein, the AI agent 192 may use an RAG approach to determine the data (or to generate a response to a query submitted by the AI agent 182) for the AI agent 182. In particular, based on the information request or the query submitted by the AI agent 182, the AI agent 192 may retrieve one or more documents from a data storage accessible by the AI agent 192, and generate the data based on the content from the one or more documents. As such, the smart contract may also be generated to dynamically determine the number of tokens to be transferred from the digital wallet associated with the AI agent 182 to the digital wallet associated with the AI agent 192 based on the quantity and/or the quality of the one or more documents.

In some embodiments, the metrics for evaluating the quality of the data/response and/or the documents may be specified by the AI agent 182 (e.g., specified in the request, etc.) or by the AI agent 192. As such, the smart contract generation module 308 may incorporate the metrics into the smart contract, and record the smart contract on the blockchain associated with the blockchain network 180.

In another example, if the request is for purchasing one or more items from a merchant associated with the AI agent 192, the smart contract generation module 308 may generate a smart contract that triggers a transfer of tokens from the digital wallet associated with the AI agent 182 to the digital wallet associated with the AI agent 192 upon detecting a shipment of the one or more items from the merchant.

On or more computer nodes associated with the blockchain network 180 may execute the smart contract. In some embodiments, when the service provider server 130 is one of the computer nodes associated with the blockchain network 180, the transaction module 300 may use the transaction execution module 310 to execute the smart contract. By executing the smart contract, the one or more computer nodes may monitor the condition specified in the smart contract. For example, the one or more computer nodes may detect whether the condition is satisfied (e.g., whether data has been delivered to the AI agent 182, whether a shipment has been sent from the merchant, etc.). When the smart contract includes metrics for calculating the tokens to be transferred to the digital wallet of the AI agent 192, the one or more computer nodes may calculate the number of tokens to be transferred based on the metrics. For example, after detecting the delivery of content (e.g., a response to a query, etc.) to the AI agent 182, the one or more computer nodes may evaluate the quantity and/or the quality of the content delivered to the AI agent 182, and/or the quantity and/or the quality of the documents used by the AI agent 192 to generate the content. The one or more computer nodes may then calculate the number of tokens to be transferred to the digital wallet of the AI agent 192 based on the metrics. The one or more computer nodes may then initiate a blockchain transaction for transferring the number of tokes from the digital wallet of the AI agent 182 to the digital wallet of the AI agent 192.

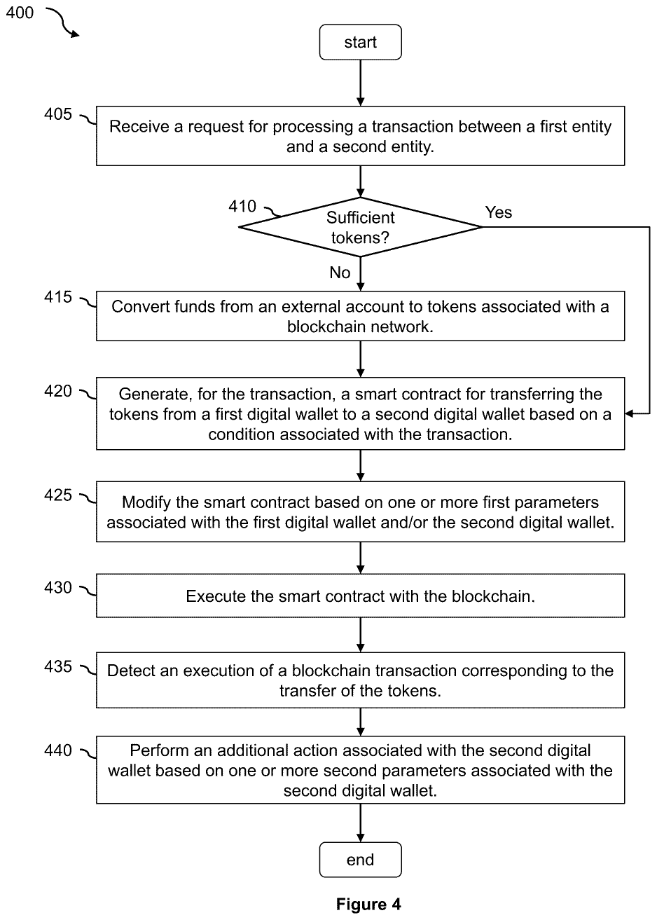

FIG. 4 illustrates a process 400 for facilitating transactions according to various embodiments of the disclosure. In some embodiments, at least a portion of the process 400 may be performed by the transaction module 132, although one or more steps may be performed by one or more of the components/devices/modules/systems described herein. The process 400 begins by receiving (at step 405) a request for processing a transaction between a first entity and a second entity. For example, the transaction module 132 may receive a transaction request from one of the first entity or the second entity. One or more of the first entity and the second entity may be a human user (e.g., the user 140, etc.), an organization (e.g., the merchant associated with the merchant server 120, etc.), or an AI agent (e.g., the AI agent 182, the AI agent 192, etc.). The transaction request may be associated with a transaction that involves a transfer of tokens from one digital wallet (e.g., a digital wallet of the first entity) to another digital wallet (e.g., a digital wallet of the second entity).

The transaction module 132 then determines (at step 410) whether the digital wallet of the first entity has sufficient tokens for the transaction. If the digital wallet of the first entity does not have sufficient tokens for the transaction, the transaction module 132 converts (at step 415) funds from an external account to tokens associated with a blockchain network. For example, the transaction module 132 may access an account associated with the first entity based on data associated with the digital wallet of the first entity, and may transfer funds from the account to an account associated with the transaction module 132. The transaction module 132 may then transfer one or more tokens from a digital wallet of the service provider server 130 to the digital wallet of the first entity for processing the transaction.

The transaction module 132 then uses the smart contract generation module 308 to generate (at step 420), for the transaction, a smart contract for transferring the tokens from a first digital wallet of the first entity to a second digital wallet of the second entity based on a condition associated with the transaction. For example, the transaction module 132 may use the smart contract generation module 308 to generate a smart contract for the transaction. The smart contract generation module 308 may generate the smart contract based on the information associated with the transaction. For example, the smart contract generation module 308 may determine the condition based on the nature of the transaction. If the transaction is associated with a purchase of one or more items from the second entity, the smart contract generation module 308 may generate the smart contract to include a condition associated with a shipment or a delivery of the one or more items. If the transaction is associated with an inquiry for information from the second entity (e.g., based on a query submitted from the first entity to the second entity, etc.), the smart contract generation module 308 may generate the smart contract to include a condition associated with a delivery of the requested information.

The transaction module 132 then modifies (at step 425) the smart contract based on one or more first parameters associated with the first digital wallet and/or the second digital wallet. For example, when the request is associated with a delivery of information to the first entity, the first digital wallet and/or the second digital wallet may include data (e.g., parameters) that indicate metrics for evaluating the information being delivered to the first entity. The metrics may be used to determine the number of tokens to be transferred to the second digital wallet upon a delivery of the information. As such, the smart contract generation module 308 may incorporate the metrics into the smart contract, and insert programming code for calculating the number of tokens to be transferred to the second digital wallet based on the metrics.

The transaction module 132 and/or a computer node associated with the blockchain network 180 executes (at step 430) the smart contract on the blockchain. By executing the smart contract, one or more computer nodes associated with the blockchain network 180 may monitor the condition included in the smart contract (e.g., a shipment of one or more items, a delivery of content, etc.), and may trigger a blockchain transaction upon a detection of the condition. The blockchain transaction may be associated with a transfer of a number of tokens from the first digital wallet to the second digital wallet.

After executing the smart contract, the transaction module 132 may monitor transactions being recorded on the blockchain. When the transaction module 132 detects (at step 435) an execution of a blockchain transaction corresponding to the transfer of the tokens from the first digital wallet to the second digital wallet, the transaction module 132 performs (at step 440) an additional action associated with the second digital wallet based on one or more second parameters associated with the second digital wallet. For example, when the second digital wallet includes parameters that indicate a conversion of the received tokens to another currency, the transaction module 132 may convert the tokens received by the second digital wallet to funds in the specified currency. When the second digital wallet includes parameters that indicate forwarding at least a portion of the received tokens to one or more other digital wallets, the transaction module 132 may initiate additional blockchain transactions for transferring the at least the portion of the received tokens to the one or more other digital wallets.

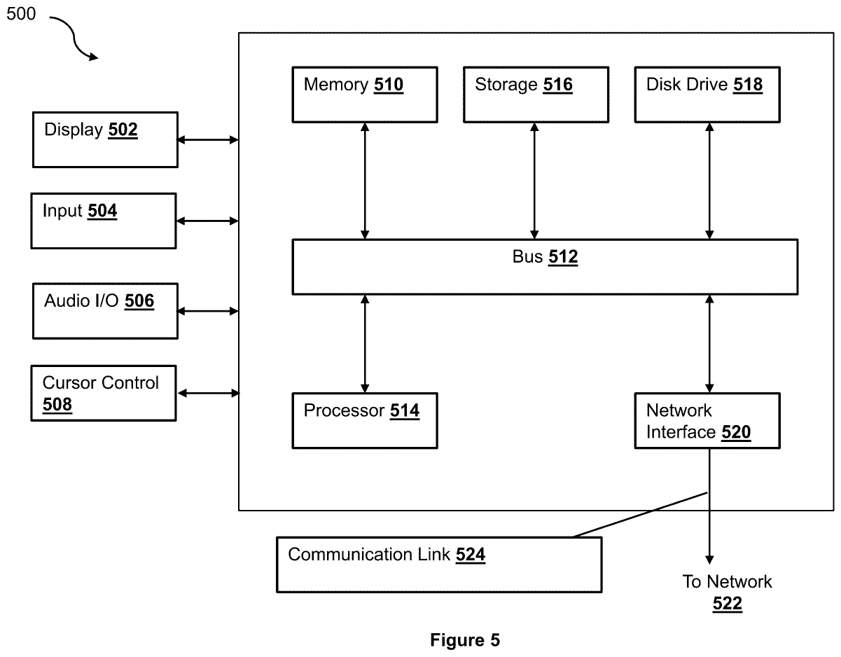

FIG. 5 is a block diagram of a computer system 500 suitable for implementing one or more embodiments of the present disclosure, including the service provider server 130, the merchant server 120, the user device 110, the computer nodes within the blockchain network 180, and the devices that execute the AI agents 182 and 192. In various implementations, the user device 110 may include a mobile cellular phone, personal computer (PC), laptop, wearable computing device, etc. adapted for wireless communication, and each of the service provider server 130, the merchant server 120, the computer nodes of the blockchain network 180, and the devices that execute the AI agents 182 and 192 may include a network computing device, such as a server. Thus, it should be appreciated that the devices 110, 120, 130, the computer nodes of the blockchain network 180, and the devices that execute the AI agents 182 and 192 may be implemented as the computer system 500 in a manner as follows.

The computer system 500 includes a bus 512 or other communication mechanism for communicating information data, signals, and information between various components of the computer system 500. The components include an input/output (I/O) component 504 that processes a user (i.e., sender, recipient, service provider) action, such as selecting keys from a keypad/keyboard, selecting one or more buttons or links, etc., and sends a corresponding signal to the bus 512. The I/O component 504 may also include an output component, such as a display 502 and a cursor control 508 (such as a keyboard, keypad, mouse, etc.). The display 502 may be configured to present a login page for logging into a user account or a checkout page for purchasing an item from a merchant. An optional audio input/output component 506 may also be included to allow a user to use voice for inputting information by converting audio signals. The audio I/O component 506 may allow the user to hear audio. A transceiver or network interface 520 transmits and receives signals between the computer system 500 and other devices, such as another user device, a merchant server, or a service provider server via a network 522. In one embodiment, the transmission is wireless, although other transmission mediums and methods may also be suitable. A processor 514, which can be a micro-controller, digital signal processor (DSP), or other processing component, processes these various signals, such as for display on the computer system 500 or transmission to other devices via a communication link 524. The processor 514 may also control transmission of information, such as cookies or IP addresses, to other devices.

The components of the computer system 500 also include a system memory component 510 (e.g., RAM), a static storage component 516 (e.g., ROM), and/or a disk drive 518 (e.g., a solid-state drive, a hard drive). The computer system 500 performs specific operations by the processor 514 and other components by executing one or more sequences of instructions contained in the system memory component 510. For example, the processor 514 can perform the transaction processing functionalities described herein.

Logic may be encoded in a computer readable medium, which may refer to any medium that participates in providing instructions to the processor 514 for execution. Such a medium may take many forms, including but not limited to, non-volatile media, volatile media, and transmission media. In various implementations, non-volatile media includes optical or magnetic disks, volatile media includes dynamic memory, such as the system memory component 510, and transmission media includes coaxial cables, copper wire, and fiber optics, including wires that comprise the bus 512. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 500. In various other embodiments of the present disclosure, a plurality of computer systems 500 coupled by the communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

In its broadest sense, blockchain refers to a framework that supports a trusted ledger that is stored, maintained, and updated in a distributed manner in a peer-to-peer network. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others the distributed ledger represents each transaction where units of the cryptocurrency are transferred between entities. For example, using a digital currency exchange, a user may buy any value of digital currency or exchange any holdings in digital currencies into worldwide currency or other digital currencies. Each transaction can be verified by the distributed ledger and only verified transactions are added to the ledger. The ledger, along with many aspects of blockchain, may be referred to as “decentralized” in that a central authority is typically not present. Because of this, the accuracy and integrity of the ledger cannot be attacked at a single, central location. Modifying the ledger at all, or a majority of, locations where it is stored is made difficult so as to protect the integrity of the ledger. This is due in large part because individuals associated with the nodes that make up the peer-to-peer network have a vested interest in the accuracy of the ledger.

Though maintaining cryptocurrency transactions in the distributed ledger may be the most recognizable use of blockchain technology today, the ledger may be used in a variety of different fields. Indeed, blockchain technology is applicable to any application where data of any type may be accessed where the accuracy of the data is assured. For example, a supply chain may be maintained in a blockchain ledger, where the transfer of each component from party to party, and location to location, may be recorded in the ledger for later retrieval. Doing so allows for easier identification of a source for a defective part and where other such defective parts have been delivered. Similarly, food items may be tracked in like manner from farm to grocery store to purchaser.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

### COMPUTING ARCHITECTURE

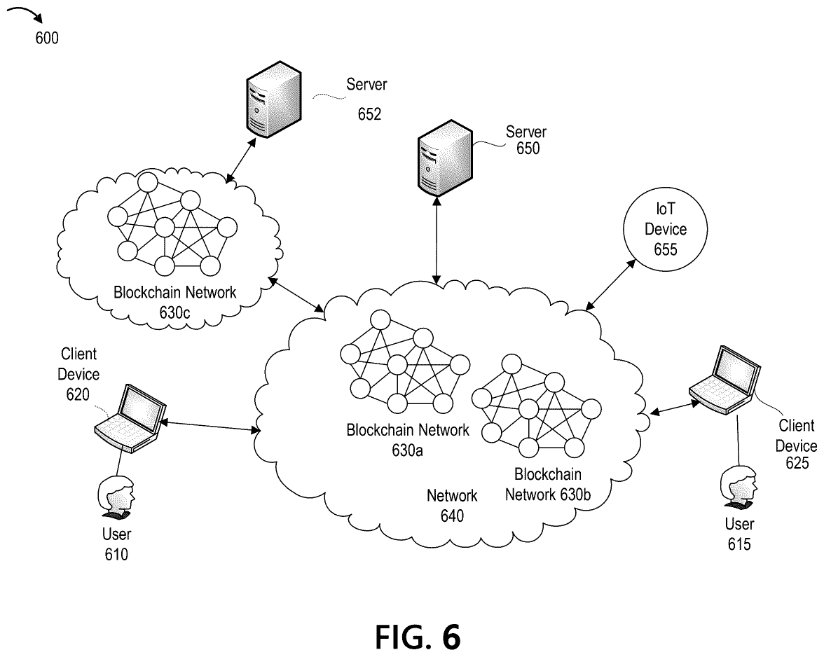

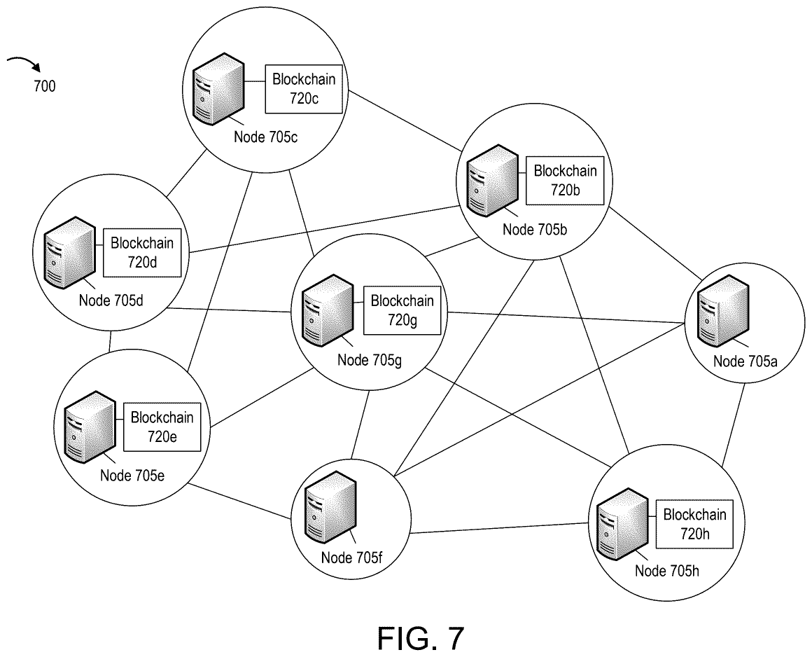

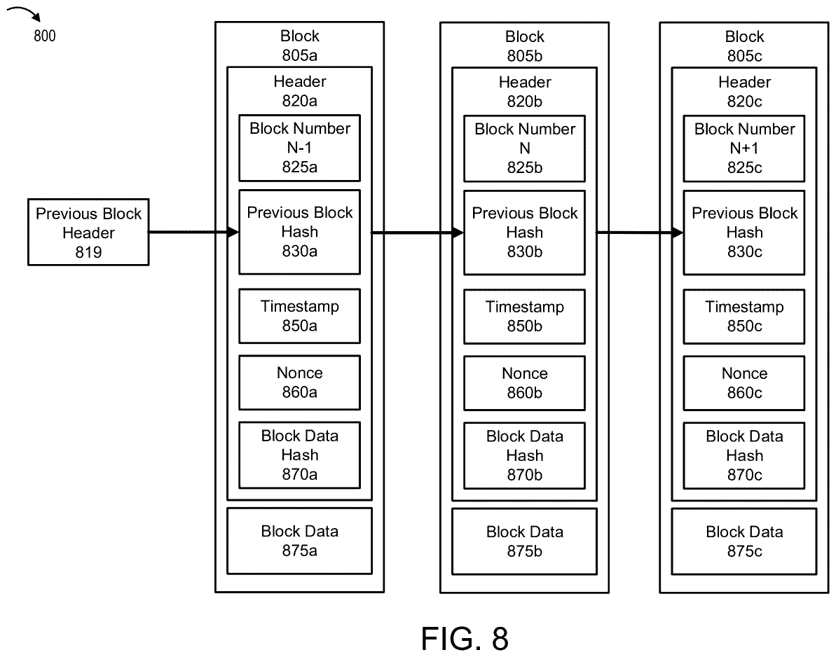

As discussed above, the distributed ledger in a blockchain framework is stored, maintained, and updated in a peer-to-peer network. In one example the distributed ledger maintains a number of blockchain transactions. FIG. 6 shows an example system 600 for facilitating a blockchain transaction. The system 600 includes a first client device 620, a second client device 625, a first server 650, and an Internet of Things (IOT) device 655 interconnected via a network 640. The first client device 620, the second client device 625, the first server 650 may be a computing device 500 described in more detail with reference to FIG. 5. The IoT device 655 may comprise any of a variety of devices including vehicles, home appliances, embedded electronics, software, sensors, actuators, thermostats, light bulbs, door locks, refrigerators, RFID implants, RFID tags, pacemakers, wearable devices, smart home devices, cameras, trackers, pumps, POS devices, and stationary and mobile communication devices along with connectivity hardware configured to connect and exchange data. The network 640 may be any of a variety of available networks, such as the Internet, and represents a worldwide collection of networks and gateways to support communications between devices connected to the network 640. The system 600 may also comprise one or more distributed or peer-to-peer (P2P) networks, such as a first, second, and third blockchain network 630a-c (generally referred to as blockchain networks 630). As shown in FIG. 6, the network 640 may comprise the first and second blockchain networks 630a and 630b. The third blockchain network 630c may be associated with a private blockchain as described below with reference to FIG. 7, and is thus, shown separately from the first and second blockchain networks 630a and 603b. Each blockchain network 630 may comprise a plurality of interconnected devices (or nodes) as described in more detail with reference to FIG. 7. As discussed above, a ledger, or blockchain, is a distributed database for maintaining a growing list of records comprising any type of information. A blockchain, as described in more detail with reference to FIG. 8, may be stored at least at multiple nodes (or devices) of the one or more blockchain networks 630.

In one example, a blockchain based transaction may generally involve a transfer of data or value between entities, such as the first user 610 of the first client device 620 and the second user 615 of the second client device 625 in FIG. 6. The server 650 may include one or more applications, for example, a transaction application configured to facilitate the transaction between the entities by utilizing a blockchain associated with one of the blockchain networks 630. As an example, the first user 610 may request or initiate a transaction with the second user 615 via a user application executing on the first client device 620. The transaction may be related to a transfer of value or data from the first user 610 to the second user 615. The first client device 620 may send a request of the transaction to the server 650. The server 650 may send the requested transaction to one of the blockchain networks 630 to be validated and approved as discussed below.

### BLOCKCHAIN NETWORK

FIG. 7 shows an example blockchain network 700 comprising a plurality of interconnected nodes or devices 705a-h (generally referred to as nodes 705). Each of the nodes 705 may comprise a computing device 500 described in more detail with reference to FIG. 5. Although FIG. 7 shows a single device 705, each of the nodes 705 may comprise a plurality of devices (e.g., a pool). The blockchain network 700 may be associated with a blockchain 720. Some or all of the nodes 705 may replicate and save an identical copy of the blockchain 720. For example, FIG. 7 shows that the nodes 705b-e and 705g-h store copies of the blockchain 720. The nodes 705b-e and 705g-h may independently update their respective copies of the blockchain 720 as discussed below.

### BLOCKCHAIN NODE TYPES

Blockchain nodes, for example, the nodes 705, may be full nodes or lightweight nodes. Full nodes, such as the nodes 705b-e and 705g-h, may act as a server in the blockchain network 700 by storing a copy of the entire blockchain 720 and ensuring that transactions posted to the blockchain 720 are valid. The full nodes 705b-e and 705g-h may publish new blocks on the blockchain 720. Lightweight nodes, such as the nodes 705a and 705f, may have fewer computing resources than full nodes. For example, IoT devices often act as lightweight nodes. The lightweight nodes may communicate with other nodes 705, provide the full nodes 705b-e and 705g-h with information, and query the status of a block of the blockchain 720 stored by the full nodes 705b-e and 705g-h. In this example, however, as shown in FIG. 7, the lightweight nodes 705a and 705f may not store a copy of the blockchain 720 and thus, may not publish new blocks on the blockchain 720.

### BLOCKCHAIN NETWORK TYPES

The blockchain network 700 and its associated blockchain 720 may be public (permissionless), federated or consortium, or private. If the blockchain network 700 is public, then any entity may read and write to the associated blockchain 720. However, the blockchain network 700 and its associated blockchain 720 may be federated or consortium if controlled by a single entity or organization. Further, any of the nodes 705 with access to the Internet may be restricted from participating in the verification of transactions on the blockchain 720. The blockchain network 700 and its associated blockchain 720 may be private (permissioned) if access to the blockchain network 700 and the blockchain 720 is restricted to specific authorized entities, for example organizations or groups of individuals. Moreover, read permissions for the blockchain 720 may be public or restricted while write permissions may be restricted to a controlling or authorized entity.

### BLOCKCHAIN

As discussed above, a blockchain 720 may be associated with a blockchain network 700. FIG. 8 shows an example blockchain 800. The blockchain 800 may comprise a plurality of blocks 805a, 805b, and 805c (generally referred to as blocks 805). The blockchain 800 comprises a first block (not shown), sometimes referred to as the genesis block. Each of the blocks 805 may comprise a record of one or a plurality of submitted and validated transactions.

The blocks 805 of the blockchain 800 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 800 may be stored locally, in the cloud, on grid, for example by the nodes 705b-e and 705g-h, as a file or in a database.

### BLOCKS

Each of the blocks 805 may comprise one or more data fields. The organization of the blocks 305 within the blockchain 800 and the corresponding data fields may be implementation specific. As an example, the blocks 805 may comprise a respective header 820a, 820b, and 820c (generally referred to as headers 820) and block data 875a, 875b, and 875c (generally referred to as block data 875). The headers 820 may comprise metadata associated with their respective blocks 305. For example, the headers 820 may comprise a respective block number 825a, 825b, and 825c. As shown in FIG. 8, the block number 825a of the block 805a is N−1, the block number 825b of the block 805b is N, and the block number 825c of the block 805c is N+1. The headers 820 of the blocks 805 may include a data field comprising a block size (not shown).

The blocks 805 may be linked together and cryptographically secured. For example, the header 820b of the block N (block 805b) includes a data field (previous block hash 830b) comprising a hash representation of the previous block N−1's header 820a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 820c of the block N+1 (block 805c) includes a data field (previous block hash 830c) comprising a hash representation of block N's (block 805b) header 820b.

The headers 820 of the blocks 805 may also include data fields comprising a hash representation of the block data, such as the block data hash 870a-c. The block data hash 870a-c may be generated, for example, by a Merkle tree and by storing the hash or by using a hash that is based on all of the block data. The headers 820 of the blocks 805 may comprise a respective nonce 860a, 860b, and 860c. In some implementations, the value of the nonce 860a-c is an arbitrary string that is concatenated with (or appended to) the hash of the block. The headers 820 may comprise other data, such as a difficulty target.

The blocks 805 may comprise a respective block data 875a, 875b, and 875c (generally referred to as block data 875). The block data 875 may comprise a record of validated transactions that have also been integrated into the blockchain 700 via a consensus model (described below). As discussed above, the block data 875 may include a variety of different types of data in addition to validated transactions. Block data 875 may include any data, such as text, audio, video, image, or file, that may be represented digitally and stored electronically.

### BLOCKCHAIN TRANSACTION

In one example, a blockchain based transaction may generally involve a transfer of data or value or an interaction between entities and described in more detail below. Referring back to FIG. 6, the server 650 may include one or more applications, for example, a transaction application configured to facilitate a blockchain transaction between entities. The entities may include users, devices, etc. The first user 610 may request or initiate a transaction with the second user 615 via a user application executing on the first client device 620. The transaction may be related to a transfer of value or data from the first user 610 to the second user 615. The value or data may represent money, a contract, property, records, rights, status, supply, demand, alarm, trigger, or any other asset that may be represented in digital form. The transaction may represent an interaction between the first user 610 and the second user 615.

FIG. 8 is a diagram of a transaction 865 generated by the transaction application. The transaction 865 may include a public key 815, a blockchain address 830 associated with the first user 610, a digital signature 855, and transaction output information 860. The transaction application may derive a public key 815 from a private key 805 of the first user 610 by applying a cryptographic hash function 810 to the private key 805. The cryptographic hash function 810 may be based on AES, SHA-2, SHA-3, RSA, ECDSA, ECDH (elliptic curve cryptography), or DSA (finite field cryptography), although other cryptographic models may be utilized. More information about cryptographic algorithms may be found in Federal Information Processing Standards Publication (FIPS PUB 180-3), Secure Hash Standard. The transaction application may derive an address or identifier for the first user 610, such as the blockchain address 830, by applying a hash function 820 to the public key 815. Briefly, a hash function is a function that may be used for mapping arbitrary size data to fixed size data. The value may also be referred to as a digest, a hash value, a hash code, or a hash. In order to indicate that the first user 610 is the originator of the transaction 865, the transaction application may generate the digital signature 855 for the transaction data 835 using the private key 805 of the first user 610. The transaction data 835 may include information about the assets to be transferred and a reference to the sources of the assets, such as previous transactions in which the assets were transferred to the first user 610 or an identification of events that originated the assets. Generating the digital signature 855 may include applying a hash function 840 to the transaction data 835 resulting in hashed transaction data 845. The hashed transaction data 845 and the transaction data 835 may be encrypted (via an encryption function 850) using the private key 805 of the first user 610 resulting in the digital signature 855. The transaction output information 860 may include asset information 850 and an address or identifier for the second user 850, such as the blockchain address 850. The transaction 865 may be sent from the first client device 625 to the server 650.

The specific type of cryptographic algorithm being utilized may vary dynamically based on various factors, such as a length of time, privacy concerns, etc. For example, the type of cryptographic algorithm being utilized may be changed yearly, weekly, daily, etc. The type of algorithms may also change based on varying levels of privacy. For example, an owner of content may implement a higher level of protection or privacy by utilizing a stronger algorithm.

### BLOCKCHAIN ADDRESSES

A blockchain network may utilize blockchain addresses to indicate an entity using the blockchain or start and end points in the transaction. For example, a blockchain address for the first user 610, shown in FIG. 8 as the blockchain address of sender 830, may include an alphanumeric string of characters derived from the public key 815 of the first user 610 based on applying a cryptographic hash function 820 to the public key 815. The methods used for deriving the addresses may vary and may be specific to the implementation of the blockchain network. In some examples, a blockchain address may be converted into a QR code representation, barcode, token, or other visual representations or graphical depictions to enable the address to be optically scanned by a mobile device, wearables, sensors, cameras, etc. In addition to an address or QR code, there are many ways of identifying individuals, objects, etc. represented in a blockchain. For example, an individual may be identified through biometric information such as a fingerprint, retinal scan, voice, facial id, temperature, heart rate, gestures/movements unique to a person etc., and through other types of identification information such as account numbers, home address, social security number, formal name, etc.

### BROADCASTING TRANSACTION

The server 650 may receive transactions from users of the blockchain network 630. The transactions may be submitted to the server 650 via desktop applications, smartphone applications, digital wallet applications, web services, or other software applications. The server 650 may send or broadcast the transactions to the blockchain network 630. FIG. 5 shows an example transaction 502 broadcast by the server 650 to the blockchain network 630. The transaction 502 may be broadcast to multiple nodes 705 of the blockchain network 630. Typically, once the transaction 502 is broadcast or submitted to the blockchain network 630, it may be received by one or more of the nodes 705. Once the transaction 502 is received by the one or more nodes 705 of the blockchain network 630, it may be propagated by the receiving nodes 705 to other nodes 705 of the blockchain network 630.

A blockchain network may operate according to a set of rules. The rules may specify conditions under which a node may accept a transaction, a type of transaction that a node may accept, a type of compensation that a node receives for accepting and processing a transaction, etc. For example, a node may accept a transaction based on a transaction history, reputation, computational resources, relationships with service providers, etc. The rules may specify conditions for broadcasting a transaction to a node. For example, a transaction may be broadcast to one or more specific nodes based on criteria related to the node's geography, history, reputation, market conditions, docket/delay, technology platform. The rules may be dynamically modified or updated (e.g. turned on or off) to address issues such as latency, scalability and security conditions. A transaction may be broadcast to a subset of nodes as a form of compensation to entities associated with those nodes (e.g., through receipt of compensation for adding a block of one or more transactions to a blockchain).

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

1. A system comprising:
a non-transitory memory; and
one or more hardware processors coupled with the non-transitory memory and configured to execute instructions from the non-transitory memory to cause the system to:
monitor one or more communications exchanged between a first artificial intelligence (AI) agent and a second AI agent via a chat interface;
detect a triggering event for a transaction request associated with the first AI agent requesting information from the second AI agent based on (i) analyzing the one or more communications exchanged between the first AI agent and the second AI agent and (ii) identifying one or more trigger words within the one or more communications;
generate, for the transaction request, a smart contract executable by a blockchain network based on a set of transaction parameters associated with at least one of a first digital wallet associated with the first AI agent or a second digital wallet associated with the second AI agent, wherein the set of transaction parameters comprises a set of evaluation metrics usable to evaluate the information to be delivered by the second AI agent, and wherein the smart contract specifies (i) a mechanism of computing an amount of tokens associated with the blockchain network based on an evaluation of the information using the set of evaluation metrics and (ii) a transfer of a set of tokens corresponding to the amount of tokens from the first digital wallet to the second digital wallet upon a detection of a delivery of the information from the second AI agent to the first AI agent via the chat interface; and
execute the smart contract with the blockchain network.

2. The system of claim 1, wherein the transaction request is associated with a query submitted by the first AI agent via the chat interface.

3. The system of claim 2, wherein the query is submitted via an application programming interface (API) call associated with the system.

4. The system of claim 1, wherein the set of evaluation metrics comprises at least one of a quality metric or a quantity metric.

5. The system of claim 1, wherein executing the instructions further causes the system to:
configure the smart contract to specify an automatic transfer of a portion of the set of tokens to a third digital wallet based on a transaction parameter from the set of transaction parameters.

6. The system of claim 1, wherein executing the instructions further causes the system to:
detect a transaction record associated with the transfer of the set of tokens from the first digital wallet to the second digital wallet on a blockchain associated with the blockchain network; and
perform an action associated with the second digital wallet based on one or more transaction parameters associated with the second digital wallet.

7. The system of claim 6, wherein the set of tokens is associated with a first cryptocurrency, and wherein the action comprises converting at least a portion of the set of tokens from the first cryptocurrency to a second currency.

8. A method, comprising:
monitoring, by a computer system and via an interface, one or more utterances exchanged between a first artificial intelligence (AI) agent and a second AI agent;
detecting, by the computer system, a triggering event for a transaction request associated with the first AI agent requesting one or more items from the second AI agent based on (i) analyzing the one or more utterances exchanged between the first AI agent and the second AI agent and (ii) identifying one or more trigger words within the one or more utterances;
determining, by the computer system, a set of parameters for processing the transaction request, wherein the set of parameters is associated with at least one of a first digital wallet associated with the first AI agent or a second digital wallet associated with the second AI agent;
generating, by the computer system and for the transaction request, a smart contract executable by a blockchain network based on the set of parameters, wherein the set of parameters comprises a set of evaluation metrics usable to evaluate the one or more items to be delivered by the second AI agent, and wherein the smart contract specifies (i) a mechanism of computing an amount of tokens associated with the blockchain network based on an evaluation of the one or more items using the set of evaluation metrics and (ii) a transfer of a set of tokens corresponding to the amount of tokens from the first digital wallet to the second digital wallet upon a detection of a delivery of the one or more items to the first AI agent; and
executing, by the computer system, the smart contract with the blockchain network.

9. The method of claim 8, wherein the one or more items comprise content associated with a particular domain.

10. The method of claim 8, wherein the one or more utterances are exchanged via a chat interface.

11. The method of claim 8, wherein the set of evaluation metrics is associated with one of a quality of the one or more items or a quantity of the one or more items.

12. The method of claim 8, wherein the second AI agent is configured to retrieve a set of documents usable for generating the one or more items, and wherein the set of evaluation metrics is associated with one of a quality of the set of documents or a quantity of the set of documents.

13. The method of claim 8, wherein the one or more items are usable by the first AI agent to generate a response to a user query.

14. The method of claim 8, chat interface, and wherein the one or more items are delivered to the first AI agent via a chat interface.

15. A non-transitory machine-readable medium having stored thereon machine-readable instructions executable to cause a machine to perform operations comprising:
monitoring one or more communications exchanged between a first artificial intelligence (AI) agent and a second AI agent via an interface;
receiving detecting a triggering event associated with a transaction request based on (i) analyzing the one or more communications exchanged between the first AI agent and the second AI agent and (ii) identifying one or more trigger words within the one or more communications, wherein the transaction request is associated with a delivery of one or more items from the second AI agent to the first AI agent;
generating, for the transaction request, a smart contract executable by a blockchain network based on a set of parameters associated with at least one of a first digital wallet associated with the first AI agent or a second digital wallet associated with the second AI agent, wherein the set of parameters comprises a set of evaluation metrics usable to evaluate the one or more items to be delivered by the second AI agent, and wherein the smart contract specifies (i) a mechanism of computing an amount of tokens associated with the blockchain network based on an evaluation of the one or more items using the set of evaluation metrics and (ii) a transfer of a set of tokens corresponding to the amount of tokens from the first digital wallet to the second digital wallet upon a detection of a delivery of the one or more items from the second AI agent to the first AI agent; and
executing the smart contract with the blockchain network.

16. The non-transitory machine-readable medium of claim 15, wherein the operations further comprise:
determining that a token balance of the first digital wallet is less than the amount of tokens associated with the transaction request; and
initiating a transfer of one or more additional tokens to the first digital wallet using an external account associated with the first AI agent based on account data stored in association with the first digital wallet.

17. The non-transitory machine-readable medium of claim 15, wherein the one or more communications are exchanged during a communication session between the first AI agent and the second AI agent.

18. The non-transitory machine-readable medium of claim 17, wherein the interface is a chat interface.

19. The non-transitory machine-readable medium of claim 15, wherein the one or more items comprise content associated with a particular domain.

20. The non-transitory machine-readable medium of claim 19, wherein the set of evaluation metrics comprises at least one of a quality metric or a quantity metric.
